(19) United States
(12) Patent Application Publication
(10) Pub. No.: US 2006/0244247 A1
(43) Pub. Date: Nov. 2, 2006

(54) Gas bag module

(75) Inventors: Jens Debler, Herlikofen (DE); Joachim Lutz, Schechingen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/411,514

(22) Filed: Apr. 26, 2006

(30) Foreign Application Priority Data
Apr. 29, 2005 (DE) 10 2005 020 053.2

(51) Int. Cl. B60R 21/26; B60R 21/239

(52) U.S. Cl. 280/739; 280/743.2

(57) ABSTRACT

A gas bag module for a vehicle occupant restraint device has a gas generator for inflating a gas bag, at least one discharge opening that is formed in a rigid component of the gas bag module and through which gas can be discharged that is produced by the gas generator and conveyed into the gas bag, and at least one valve flap, which in a closed position closes off the discharge opening and in an open position releases the discharge opening. The gas generator is arranged in an interior of the gas bag, and a wall section of the gas bag that covers the discharge opening is configured such that, when a pre-determined interior pressure is reached, it tears and releases the discharge opening.

### TECHNICAL FIELD

The present invention relates to a gas bag module for a vehicle occupant restraint device.

### BACKGROUND OF THE INVENTION

Usually, in a gas bag module, a gas bag is intended to be inflated as rapidly as possible with gas that is produced by a gas generator. However, in certain cases, it is desirable not to inflate the gas bag with the entire available volume of gas, or, more generally, to discharge gas, for this purpose discharge openings being provided in the gas bag module, the release of which makes it possible to limit the pressure in the gas bag.

US 2004/0232677 A1 discloses a gas bag module in which several valve flaps, which can close off or release a plurality of discharge openings that are formed in a gas generator support, are connected by catch straps to a part of the gas bag wall that faces the vehicle occupant. When the gas bag module is activated, the valve flaps are in an open position, pointing towards the outside, or they are initially closed and are opened as a consequence of the increasing pressure in the gas bag interior. Therefore, the gas bag is not inflated with the entire available volume of gas. If the deploying gas bag comes into contact with the vehicle occupant before the gas bag has sufficiently deployed so that the catch straps are tightened, then the discharge openings remain open. In this way, the pressure of the deploying gas bag and therefore the force that is exerted upon the vehicle occupant are reduced. If the vehicle occupant is situated further from the gas bag module, then the gas bag deploys as described above, at first slowly, the discharge openings being open. However, as soon as the gas bag has deployed to the point that the catch straps are tightened, they pull the valve flaps towards the interior, as a result of which the discharge openings are closed off against the interior pressure of the gas bag. As a result, little or no gas is discharged through the discharge openings, and the entire volume of gas is used to inflate the gas bag.

In the approach described, the gas generator must be arranged such that it initially injects into a housing of the gas bag module. An inflation opening of the gas bag is secured by a retaining ring in an edge area of the essentially pot-shaped housing such that the discharge openings are situated between the gas generator and the inflation opening of the gas bag.

In contrast, the present invention provides a gas bag module in which, when the gas bag module is activated, the gas generator injects directly into the gas bag.

### BRIEF SUMMARY OF THE INVENTION

This is achieved in a gas bag module for a vehicle occupant restraint device, having a gas generator for inflating a gas bag, at least one discharge opening that is formed in a rigid component of the gas bag module and through which gas can be discharged that is produced by the gas generator and conveyed into the gas bag, and at least one valve flap, which in a closed position closes off the discharge opening and in an open position releases the discharge opening. The gas generator is arranged in an interior of the gas bag, and a wall section of the gas bag that covers the discharge opening is configured such that, when a pre-determined interior pressure is reached, it tears and releases the discharge opening. The rigid component of the gas bag module in which the discharge opening is formed is intended to mean a rather or almost inflexible component such as a module housing or a gas generator support. Therefore, the principle that is known from US 2004/0232677 A1 can be realized in a so-called integrated gas bag module by the configuration according to the present invention. In the case of the present invention, the gas generator is almost completely enclosed by gas bag fabric, and only one or more igniters or attachment bolts of the gas generator pass to the outside through appropriate openings in the gas bag fabric. In this context, the gas generator injects directly into the gas bag, which advantageously influences the rapid deployment of the gas bag. As a result of the fact that the discharge opening in the installed condition is covered at least by the wall section of the gas bag, in the case of an approach featuring an initially open valve flap, foreign bodies such as dirt are effectively prevented from penetrating through the open flap into the gas bag.

Preferably, at least one tensile strap is provided, whose first end is connected to a wall part of the gas bag which wall part in the inflated condition is close to an occupant, and whose second end interacts with the valve flap. The tensile strap advantageously is of a length such that it is tightened when the gas bag in being activated expands without hindrance. In this manner, a simple mechanism is provided that is not susceptible to malfunctioning.

According to one preferred embodiment, when the tensile strap is tightened, the valve flap is placed in the closed position. This is precisely the case when the gas bag in being activated is able to expand without hindrance, i.e., for example, when it does not encounter at an early point in time a vehicle occupant who is situated closer to the gas bag module than usual.

A retaining device can be provided that initially holds the valve flap in the open position. As a result, it is possible to achieve a softer gas bag even in an initial phase of the gas bag deployment, as a result of which the force exerted upon the vehicle occupant is reduced.

The second end of the tensile strap is preferably connected to the retaining device. By a tightening of the tensile strap, the retaining device can be released. Therefore, if the gas bag expands without hindrance, thus resulting in a tightening of the tensile strap, then the valve flap that is no longer retained by the retaining device is brought into its closed position by the gas bag interior pressure. Thus the entire (remaining) volume of gas is used for deploying the gas bag and an optimal restraining effect is made available to the occupant.

According to a first embodiment, the retaining device has a latching lever. The latter directly engages the opened valve flap and distinguishes itself by an especially simple configuration as well as a cost-effective manufacturing process.

According to another embodiment, the retaining device has a destructible connecting part. In this context, the latter can possibly be a pre-damaged fabric or plastic part, which is connected to the valve flap or is molded integrally therewith. As a result of the tensile force of the tightened tensile strap, the connecting part rips or breaks and thus releases the valve flap, which thereupon moves into the closed position.

The valve flap can in the open position protrude into an interior space of the gas bag module. The advantage in this configuration lies in the fact that the flap, after it is closed, remains in its closed position due to the gas bag interior pressure even when the tensile strap is slack in response to the vehicle occupant's plunging into the gas bag.

Alternatively, the valve flap in the open position, seen from the gas bag module, protrudes outwards. Then it is possible that the closed flap is once again opened due to the gas bag interior pressure, with the tensile strap slackened (such as in response to the occupant's plunging into the gas bag), as a result of which a softer gas bag is presented to the occupant.

The valve flap is preferably connected to the second end of the tensile strap. It is then closed by the tensile strap in opposition to the interior pressure.

Advantageously, a mechanism is provided that holds the valve flap in the closed position after the tensile strap has been tightened. Therefore, in the event that the valve flap is opened outwards, the mechanism prevents a repeated opening of the flap (after closing).

The mechanism can be a clamping mechanism, which acts upon the tensile strap. A clamping mechanism of this type is simply designed, cost-effective, but also effective.

According to one configuration, the valve flap is a part of a valve component that is arranged in the interior of the gas bag and that has a frame that surrounds the valve flap. Alternatively, the valve flap can be part of a valve component that is mounted on an outside of the module housing. The valve component is simply inserted into the gas bag, or is attached to the module housing, and acts to secure the valve flap in the module.

The valve flap is preferably an integral component part of the valve component, which can be made of plastic, e.g., in an injection molding method.

The gas generator does not have to be directly connected to the valve component. However, the valve component can loosely contact the gas generator and can be secured to the module housing together with it by a common attachment means.

According to one embodiment, the wall section of the gas bag that covers the discharge opening is pre-damaged in a controlled manner. When the gas bag interior pressure rises, the wall section tears and releases the discharge opening.

### BRIEF DESCRIPTION OF THE DRAWINGS

FIG. 1 depicts a sectional view of a gas bag module according to a first embodiment of the present invention, in the installed condition;

FIG. 2 depicts a sectional view of the gas bag module from FIG. 1 in an activated condition, having an open valve flap;

FIG. 3 depicts a sectional view of the gas bag module from FIG. 1 in the activated condition, having a closed valve flap;

FIG. 4 depicts a detailed view of a gas bag module similar to that from FIG. 1;

FIG. 5 depicts a further detailed view of the gas bag module from FIG. 4;

FIG. 6 depicts a sectional view of a gas bag module according to a second embodiment of the present invention, in the installed condition;

FIG. 7 depicts a sectional view of the gas bag module from FIG. 6 in the activated condition, having a closed valve flap;

FIG. 8 depicts a sectional view of a gas bag module according to a third embodiment of the present invention, in the installed condition;

FIG. 9 depicts a sectional view of the gas bag module from FIG. 8 in the activated condition, having an open valve flap;

FIG. 10 depicts a perspective view of a gas bag module that is similar to that from FIG. 8, in the installed condition; and

FIG. 11 depicts an exploded view of another alternative configuration of the gas bag module from FIG. 8.

### DETAILED DESCRIPTION OF THE PREFERRED EMBODIMENTS

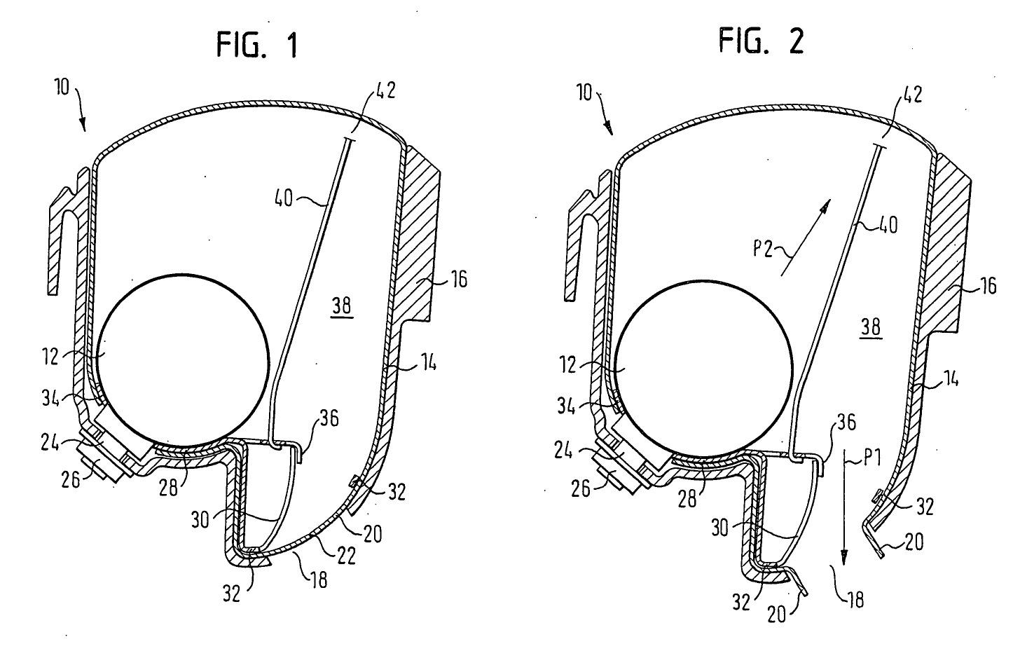

FIG. 1 shows a gas bag module 10, which is especially provided for use as a passenger-side gas bag module, but which is not limited thereto. Gas bag module 10 has a gas generator 12 and a gas bag 14, which in the Figure is only sketched. In a rigid component of gas bag module 10 in the form of a housing 16, a discharge opening 18 is provided that, in the installed condition of module 10 as shown in FIG. 1, is covered only by a wall section 20 of gas bag 14. Wall section 20 prevents foreign bodies from penetrating into gas bag 14 through the otherwise open discharge opening 18, and it has a predetermined breaking point in the form of a perforation 22 running roughly down the center over discharge opening 18.

Gas bag module 10 is a so-called integrated module, which means that gas generator 12 is arranged entirely within the interior of gas bag 14 and, when activated, injects directly into it. Only an igniter 24 of gas generator 12 passes through gas bag 14 and housing 16 to the outside and is attached by a nut 26 to housing 16.

Between gas generator 12 and gas bag 14, a valve component 28 is inserted that includes a valve flap 30 and a frame 32 that surrounds valve flap 30. Valve component 28 also has a flange 34 that rests against gas generator 12 and through which igniter 24 passes, and a retaining device in the form of a latching lever 36, which is integrally formed with the rest of valve component 28. Valve flap 30 is also integrally executed with the rest of valve component 28. In the installed condition of gas bag module 10 as shown in FIG. 1, before a possible activation, valve flap 30 is in an open position, in which it protrudes into an interior space 38 of gas bag module 10. Valve flap 30 is held in this open position by latching lever 36, which it contacts with biasing.

A first end of a tensile strap 40 is connected to a wall part 42 of gas bag 14, which in the inflated condition of gas bag 14 is close to the vehicle occupant. A second end of tensile strap 40 is secured to latching lever 36.

If an accident is detected by an appropriate sensor device (not shown), gas generator 12 is ignited and produces a flow of gas, as a result of which the interior pressure in gas bag 14 rises. A cover (also not shown) of gas bag module 10 facing the passenger area opens, and gas bag 14 begins to deploy. Due to the increasing interior pressure within gas bag 14, wall section 20 of gas bag 14 rips along perforation 22, and gas can be discharged from gas bag module 10 through discharge opening 18 (see FIG. 2, arrow P1).

In the event that gas bag 14 can deploy without hindrance, for example, in not encountering a vehicle occupant at an early point in time, tensile strap 40 is pulled upwards in the direction of arrow P2 in FIG. 2 by wall part 42, which is moving towards the vehicle occupant, and in this way the tensile strap is tightened.

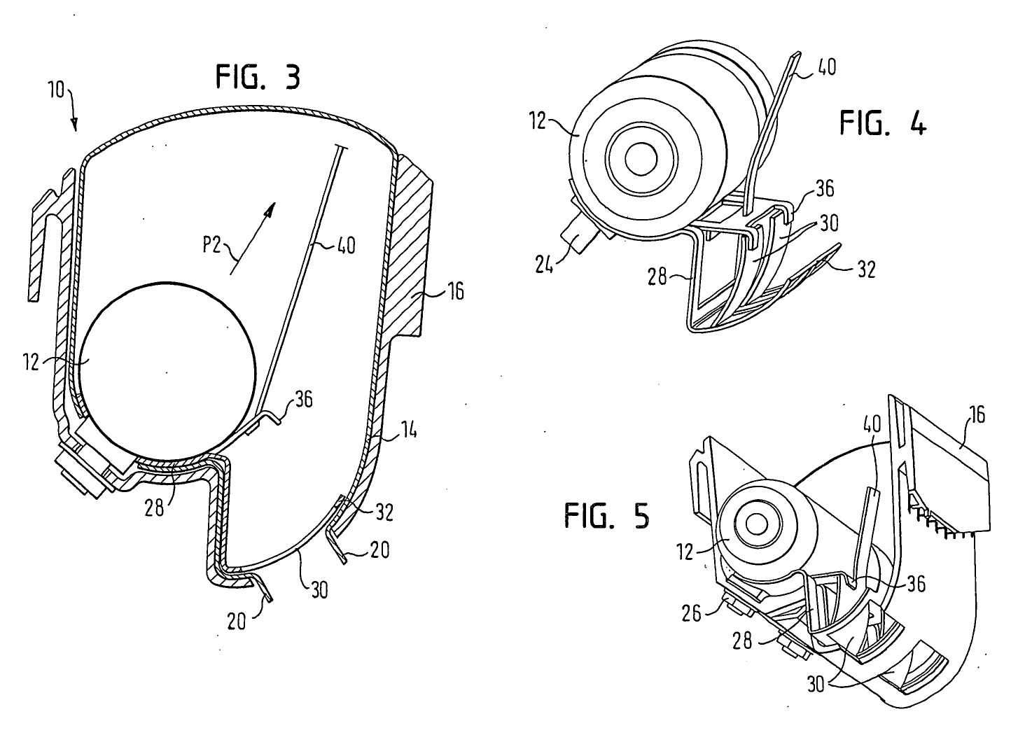

In the process, tensile strap 40 pulls latching lever 36 out of engagement with valve flap 30, which as a result is unlatched and closes due to the interior pressure within gas bag 14, i.e., the gas flow from gas generator 12 towards discharge opening 18 (see FIG. 3). As a result, a further discharge of gas from gas bag 14 is prevented, and gas bag 14 offers the vehicle occupant an optimal restraining effect. However, if the deployment of gas bag 14 is hindered, for example, by a vehicle occupant who is situated closer than usual to gas bag module 10, then tensile strap 40 remains slack, and latching lever 36 is not unlatched. Valve flap 30 therefore remains in the open position shown in FIG. 2, as a result of which a softer gas bag 14 is presented to the vehicle occupant.

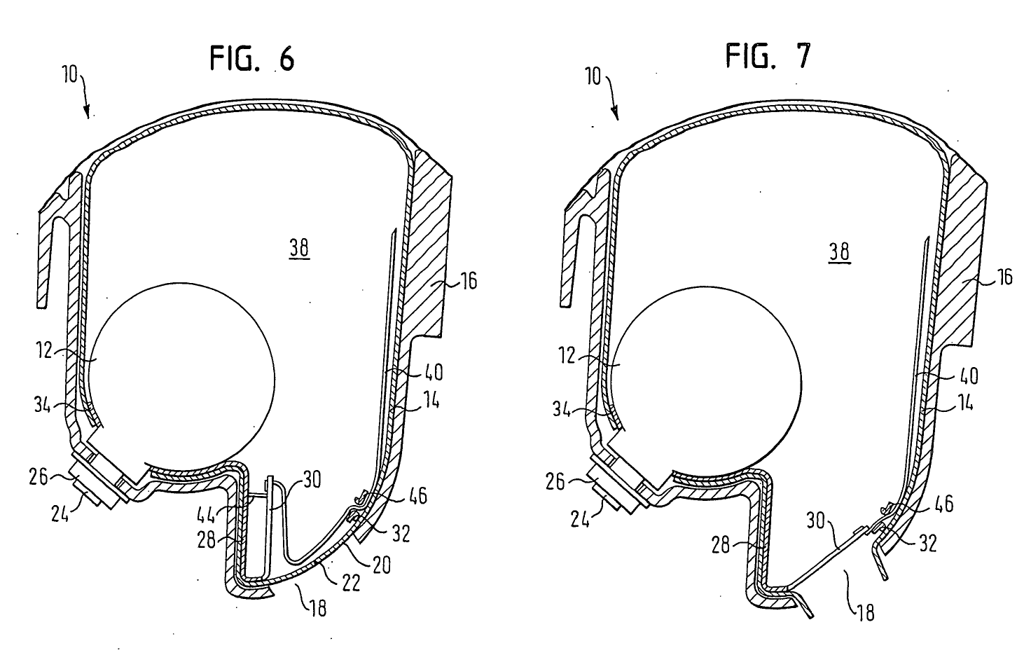

FIGS. 4 and 5 show detailed views of a gas bag module that is similar to that in FIGS. 1 to 3 in the non-activated condition. This gas bag module has two valve flaps 30, which are held by a common latching lever 36. For illustrative purposes, the Figures show no depiction of the gas bag (FIG. 5) or the gas bag and the housing (FIG. 4).

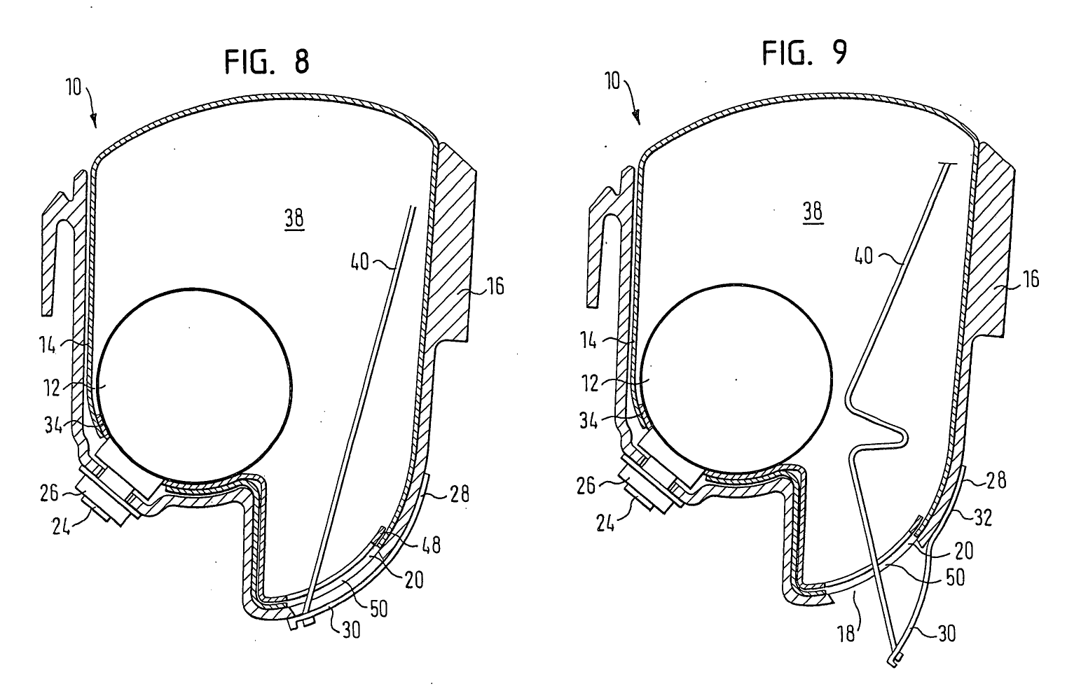

A gas bag module 10 according to a second embodiment of the present invention is shown in FIG. 6, identical components bearing identical reference numerals, and only the differences with respect to the first embodiment being discussed below. Valve component 28 in accordance with FIG. 6, which is arranged in the interior of gas bag 14, similarly has a retaining device, but instead of a latching lever a destructible connecting part 44 is provided that initially holds valve flap 30 in the open position. Connecting part 44 can be, for example, a pre-damaged fabric or plastic part. In order to ensure that connecting part 44 is reliably destroyed in the event of the tightening of tensile strap 40, valve component 28 additionally has a deflection means 46 attached to it, through which tensile strap 40 is guided. The deflection means ensures that the force exerted by tensile strap 46 acts in the direction of connecting part 44.

Because the mode of functioning of gas bag module 10 according to the second embodiment corresponds to that of the first embodiment (FIGS. 1 through 5) of the gas bag module, the mode of functioning will not be explained again. FIG. 7 shows the gas bag module 10 from FIG. 6 in the activated condition, after tensile strap 40 has tightened and valve flap 30 has closed.

FIG. 8 shows a third embodiment of a gas bag module 10 according to the present invention, which essentially differs from those described above in the fact that valve flap 30 in the open position, seen from gas bag module 10, is situated outside gas bag 14. Therefore, no retaining device is provided on valve component 28, but rather tensile strap 40 at its second end is directly connected to valve flap 30.

Furthermore, the gas bag module in accordance with FIG. 8 is different in that valve component 28 is arranged on the outside of housing 16 and is connected by housing 16 to a frame 48 that is situated in the interior of gas bag 14. Frame 48 also has a recess in the area of discharge opening 18. In the installed condition shown in FIG. 8, before the activation of gas bag module 10, valve flap 30 is closed. Wall section 20 of gas bag 14, which is arranged in the area of discharge opening 18, has a slot 50, through which tensile strap 40 passes outside to valve flap 30.

In the third embodiment of gas bag module 10 as well, gas generator 12 in being activated is first ignited and produces a gas flow, as a result of which the interior pressure in gas bag 14 rises. Subsequently, the cover of module 10 opens, and gas bag 14 begins to deploy. As a result of the increasing interior pressure, wall section 20 in the area of slot 50 tears, and valve flap 30 is pressed open (FIG. 9).

In place of slot 50, wall section 20 could also have a larger opening, even in the installed condition, through which the gas can flow.

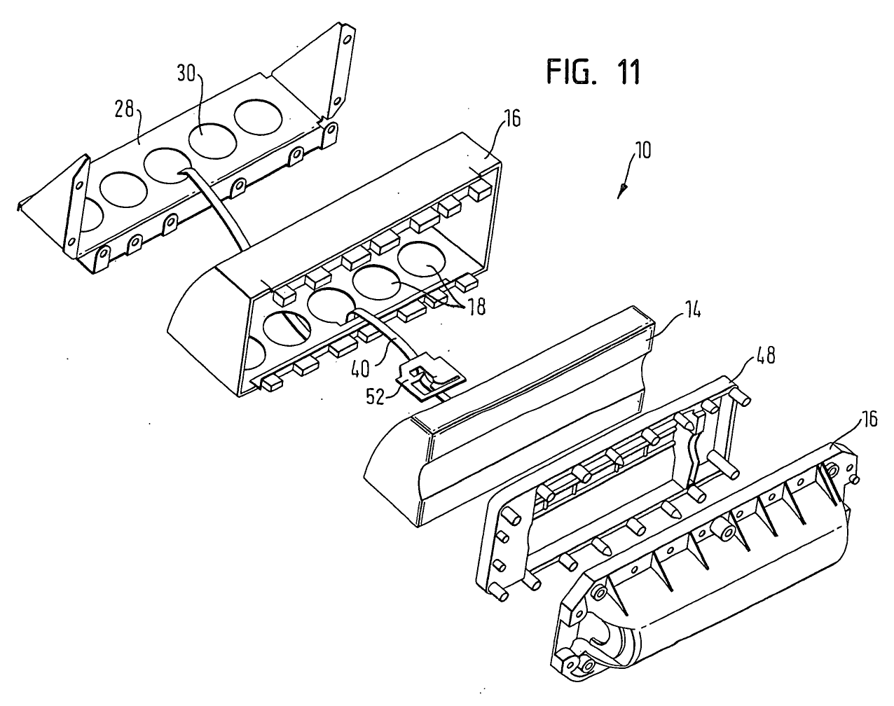

In the event that gas bag 14 can deploy without hindrance, tensile strap 40 is tightened, and valve flap 30 is pulled closed. Optionally, a clamping mechanism 52 can be provided on tensile strap 40 (FIG. 11), by which valve flap 30, once it is closed, is held in its closed position against the interior pressure of gas bag 14.

On the other hand, if the deployment of gas bag 14 is hindered, tensile strap 40 remains slack and as a result valve flap 30 remains open.

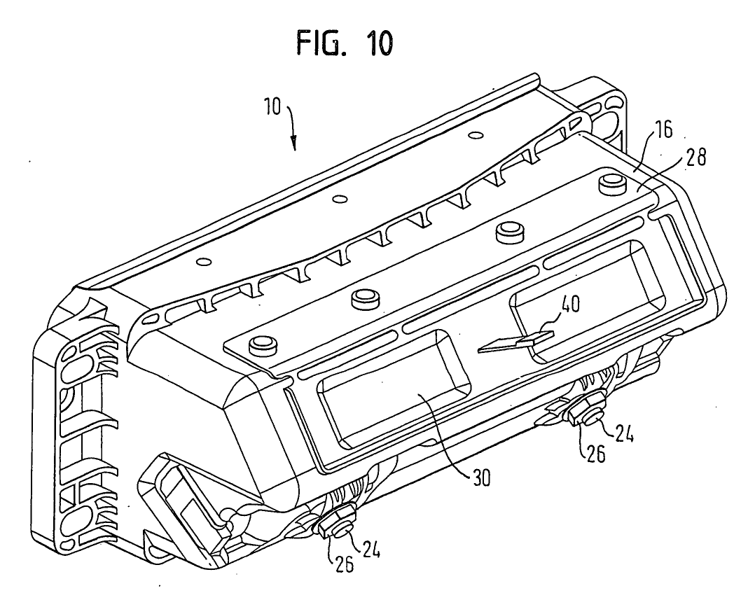

Finally, FIGS. 10 and 11 show alternative configurations of gas bag module 10, which have a valve flap 30 that opens outwards and which have a plurality of discharge openings 18 in housing 16 that are selectively configured so as to be rectangular or round and that can be closed by a common valve flap 30.

1. A gas bag module for a vehicle occupant restraint device, having
a gas generator (12) for inflating a gas bag (14),
at least one discharge opening (18) that is formed in a rigid component of said gas bag module (10) and through which gas can be discharged that is produced by said gas generator (12) and conveyed into said gas bag (14),
and at least one valve flap (30), which in a closed position closes off said discharge opening (18) and in an open position releases said discharge opening (18),
said gas generator (12) being arranged in an interior of said gas bag (14), and a wall section (20) of said gas bag (14) covering said discharge opening (18) being configured such that, when a pre-determined interior pressure is reached, it tears and releases said discharge opening (18).

2. The gas bag module as recited in claim 1, wherein at least one tensile strap (40) is provided, whose first end is connected to a wall part (42) of said gas bag (14) which wall part in an inflated condition is close to an occupant, and whose second end interacts with said valve flap (30).

3. The gas bag module as recited in claim 2, wherein said tensile strap (40) is of a length such that it is tightened when said gas bag (14) in being activated expands without hindrance.

4. The gas bag module as recited in claim 2, wherein, when said tensile strap (40) is tightened, said valve flap (30) is placed in said closed position.

5. The gas bag module as recited in claim 1, wherein a retaining device is provided that initially holds said valve flap (30) in said open position.

6. The gas bag module as recited in claim 5, wherein at least one tensile strap (40) is provided, whose first end is connected to a wall part (42) of said gas bag (14) which wall part in an inflated condition is close to an occupant, and whose second end interacts with said valve flap (30) and is connected to said retaining device.

7. The gas bag module as recited in claim 6, wherein said retaining device is released by a tightening of said tensile strap (40).

8. The gas bag module as recited in claim 5, wherein said retaining device has a latching lever (36).

9. The gas bag module as recited in claim 5, wherein said retaining device has a destructible connecting part (44).

10. The gas bag module as recited in claim 1, wherein said valve flap (30) in said open position protrudes into an interior space (38) of said gas bag module (10).

11. The gas bag module as recited in claim 1, wherein said valve flap (30) in said open position, seen from said gas bag module (10), protrudes outwards.

12. The gas bag module as recited in claim 11, wherein at least one tensile strap (40) is provided, whose first end is connected to a wall part (42) of said gas bag (14) which wall part in an inflated condition is close to an occupant, and whose second end is connected to said valve flap (30).

13. The gas bag module as recited in claim 4, wherein a mechanism is provided that holds said valve flap (30) in said closed position after said tensile strap (40) has been tightened.

14. The gas bag module as recited in claim 13, wherein said mechanism is a clamping mechanism (52), which acts upon said tensile strap (40).

15. The gas bag module as recited in claim 1, wherein said valve flap (30) is a part of a valve component (28) that is arranged in said interior of said gas bag (14) and that has a frame (32) that surrounds said valve flap (30).

16. The gas bag module as recited in claim 1, wherein said valve flap (30) is a part of a valve component (28) that is mounted on an outside of said module housing (16).

17. The gas bag module as recited in claim 15, wherein said valve flap (30) is an integral component part of said valve component (28).

18. The gas bag module as recited in claim 16, wherein said valve flap (30) is an integral component part of said valve component (28).

19. The gas bag module as recited in claim 15, wherein said gas generator (12) is not directly connected to said valve component (28).

20. The gas bag module as recited in claim 16, wherein said gas generator (12) is not directly connected to said valve component (28).

21. The gas bag module as recited in claim 1, wherein said wall section (20) of said gas bag (14) that covers said discharge opening (18) is pre-damaged in a controlled manner.
